(19) United States
(12) Patent Application Publication
(10) Pub. No.: US 2026/0270787 A1
(43) Pub. Date: Sep. 10, 2026

(54) TECHNOLOGIES FOR QUALITY OF COMPUTING SERVICES FOR SUBNETWORKS

(71) Applicant: Apple Inc., Cupertino, CA (US)

(72) Inventors: Milan Zivkovic, Munich (DE); Alperen Gundogan, Munich (DE); Dimitrios Alanis, Munich (DE); Tarik Tabet, San Jose, CA (US); Said Medjkouh, San Diego, CA (US); Anousheh Gholami Ghavamabad, San Diego, CA (US); Panagiotis Botsinis, Munich (DE); Sameh M. Eldessoki, Munich (DE); Christian Hofmann, Munich (DE); Nikolai Bijovski Ribakov, Munich (DE)

(73) Assignee: Apple Inc., Cupertino, CA (US)

(21) Appl. No.: 19/261,860

(22) Filed: Jul. 7, 2025

(30) Foreign Application Priority Data
Mar. 7, 2025 (GR) 20250100172

(51) Int. Cl. H04W 28/08; H04W 28/02; H04W 28/24

(52) U.S. Cl. CPC H04W 28/0967; H04W 28/0268; H04W 28/24

(57) ABSTRACT

The present application relates to devices and components including apparatuses, systems, and methods for compute offloading from a user equipment (UE) of a subnetwork.

### CROSS-REFERENCE TO RELATED APPLICATION

This application claims the benefit of Greece Patent Application No. 20250100172, filed on Mar. 7, 2025, the contents of which are incorporated herein by reference in its entirety for all purposes.

### TECHNICAL FIELD

This application relates generally to communication networks and, in particular, to technologies for quality of computing services for subnetworks.

### BACKGROUND

Third Generation Partnership Project (3GPP) Technical Specifications (TSs) define standards for wireless networks. These TSs describe aspects related to signaling traffic through systems that incorporate wireless networks.

### BRIEF DESCRIPTION OF THE DRAWINGS

FIG. 1 illustrates a network environment in accordance with some embodiments.

FIG. 2 illustrates an example of compute offloading in a subnetwork, in accordance with some embodiments.

FIG. 3 illustrates an example table of quality of computing services (QoCS) flow parameters that may be configured for different subnetwork QoCS flow types, in accordance with some embodiments.

FIG. 4 illustrates an example table of QoCS flow parameters for non-guaranteed computation delay (GCD) and GCD QoCS flow types, in accordance with some embodiments.

FIG. 5 illustrates an example of local subnetwork compute offloading in a subnetwork, in accordance with some embodiments.

FIG. 6 illustrates an example of a network environment for distributed compute offloading in which the compute offloading traffic may be routed via the overlay network, in accordance with some embodiments.

FIG. 7 illustrates an example network environment for distributed compute offloading between subnetworks using network communication resources, in accordance with some embodiments.

FIG. 8 illustrates an example of a network environment for distributed compute offloading in which the compute offloading traffic may be routed via direct communication between different subnetworks, in accordance with some embodiments.

FIG. 9 illustrates an example network environment for distributed compute offloading between subnetworks using direct communication between the subnetworks, in accordance with some embodiments.

FIG. 10 illustrates an operational flow/algorithmic structure in accordance with some embodiments.

FIG. 11 illustrates another operational flow/algorithmic structure in accordance with some embodiments.

FIG. 12 illustrates another operational flow/algorithmic structure in accordance with some embodiments.

FIG. 13 illustrates a user equipment in accordance with some embodiments.

FIG. 14 illustrates a network device in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component or asset within a computing or network environment, or a physical or virtual component within, accessible by, or available to a device or component. Resources could include, but are not limited to, memory space/usage, processor/CPU time, processor/CPU usage, processor and accelerator loads, hardware time or usage, electrical power, input/output operations, ports or network sockets, channel/link allocations, throughput, or workload units. A “hardware resource” may refer to compute, storage, or networking resources provided by physical hardware elements. A “virtualized resource” may refer to compute, storage, or networking resources provided by virtualization infrastructure to an application, device, or system. The term “communication resource” may refer to resources that are accessible by, or available to, computer devices/systems for transferring information over a channel of a communication network. For example, communication resources may include, but are not limited to, time/frequency resources, code resources, modulation resources, etc. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

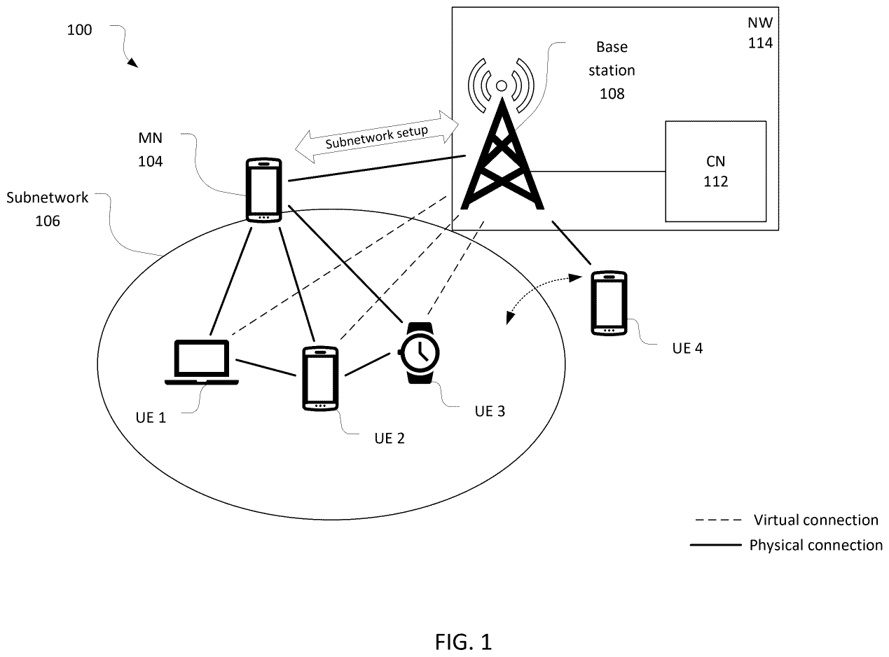

FIG. 1 illustrates a network environment 100 in accordance with some embodiments. The network environment 100 may include a base station 108 that provides one or more serving cells through which user equipments (UEs) may communicate with a cellular network. The base station 108 may be part of a radio access network (RAN) that is coupled with a core network (CN) 116. The RAN and CN 116 may be referred to, generically, as network (NW) 114 and/or overlay network.

The UEs and the base station 108 may communicate over air interfaces compatible with Fifth Generation (5G), Sixth Generation (6G), (or later) system standards as provided by 3GPP technical specifications.

The network environment 100 may include a management node (MN) 104 communicatively coupled with the base station 108 through a physical connection provided by the serving cell of the base station 108. The MN 104 may be a UE that provides a coordination role within a subnetwork 106.

The subnetwork 106 may include a number of UEs coupled with the MN 104. For example, the subnetwork 106 may include UE 1, UE 2, and UE 3. Each of these UEs may include a physical connection with the MN 104 and a virtual connection with the BS 108. The network environment 100 may also include a UE 4 that has a physical connection with the base station 108.

A physical connection, as used herein, may refer to a direct wireless connection between two devices at a physical layer of a network protocol stack. A virtual connection as used herein, may refer to a logical link between two devices. This logical link may include connections at layers above the physical layer of the network protocol stack.

The subnetwork 106 may be controlled by the MN 104 independent from an overlay network (for example, a RAN controlled by the base station 108 or the CN 112). For example, the subnetwork 106 may utilize a technology independent from the RAN technology. The subnetwork 106 may use licensed or unlicensed spectrum, resources of which are granted, scheduled, or otherwise controlled by the MN 104 independent from direct control by the base station 108.

The MN 104 may form the subnetwork 106 for the UEs without (or with limited) configuration or awareness by the base station 108. The base station 108 may communicate with the MN 104 via a physical connection and may communicate with the UEs of the subnetwork 106 logically over the virtual connections. In some embodiments, the subnetwork topology and mobility within the subnetwork 106 may be transparent to the overlay network (for example, the base station 108), which may decrease complexity of the overlay network. The MN 104 may control various aspects of the subnetwork 106 including, for example, routing and resource management. The MN 104 may provide the quality of service (QoS) that provides a reliable end-to-end (E2E) link. This may be enabled by utilizing a fair scheduling mechanism across all UEs of the subnetwork 106 and with respect to other UEs of the network environment 100.

Control plane (CP) and user plane (UP) aspects of the subnetwork 106 may facilitate flexible and efficient communication of components of the subnetwork 106. For example, CP entities can be flexibly deployed on the MN 104 or local devices and can be transferred between subnetwork nodes. These deployments may be transparent to the overlay network (e.g., NW 114). With respect to the UP aspects, higher layers may terminate at a local device (e.g., protocol data unit (PDU) Session/Internet protocol (IP) addresses), and lower layers may terminate at the MN 104 and may be subnetwork-specific within the subnetwork 106 depending on the technology used (for example, licensed vs. unlicensed, device-to-device (D2D), etc.).

In some embodiments, a UE may be associated with the overlay network (e.g., NW 114). For example, a UE of the subnetwork 106 may remain registered with the overlay network and have some aspects managed by the base station 108. For example the base station 108 may include a UE context and may control resources and mobility decisions with respect to the overlay network (for example, such as handover between base stations of a cellular network).

In some embodiments, a UE may be able to seamlessly move between the subnetwork 106 and an overlay network controlled by the base station 108. For example, the network environment 100 may include UE 4 that is capable of transitioning into, and out of, the subnetwork 106.

The MN 104 may cooperate with the base station 108 to set up the subnetwork 106. The MN 104 and the base station 108 may each include MN-interface configurations to facilitate set up and downlink/uplink signaling with respect to the subnetwork 106.

In embodiments, the subnetwork 106 may include computing offloading capability. For example, a UE of the subnetwork 106 may offload one or more compute tasks to another node (e.g., another UE) of the subnetwork 106 and/or another subnetwork. The compute tasks supported by the computing offloading capability may have different requirements, e.g., resource and/or performance requirements. Existing schemes for quality of service (QoS) and/or managing computing offloading in a wireless network may not be readily applied to subnetwork architectures, which may operate independently from the core network.

Embodiments herein provide technologies associated with a quality of computation service (QoCS) framework for compute offloading in a subnetwork. Aspects include a framework for UE-centric QoCS support in a subnetwork (e.g., without involvement of the overlay network) and a framework for network-assisted QoCS support in a subnetwork. Aspects further include QoCS parameters and/or characteristics for subnetworks. Aspects further include procedures to support subnetwork QoCS for local computation offloading within a subnetwork and/or for computation offloading between different subnetworks.

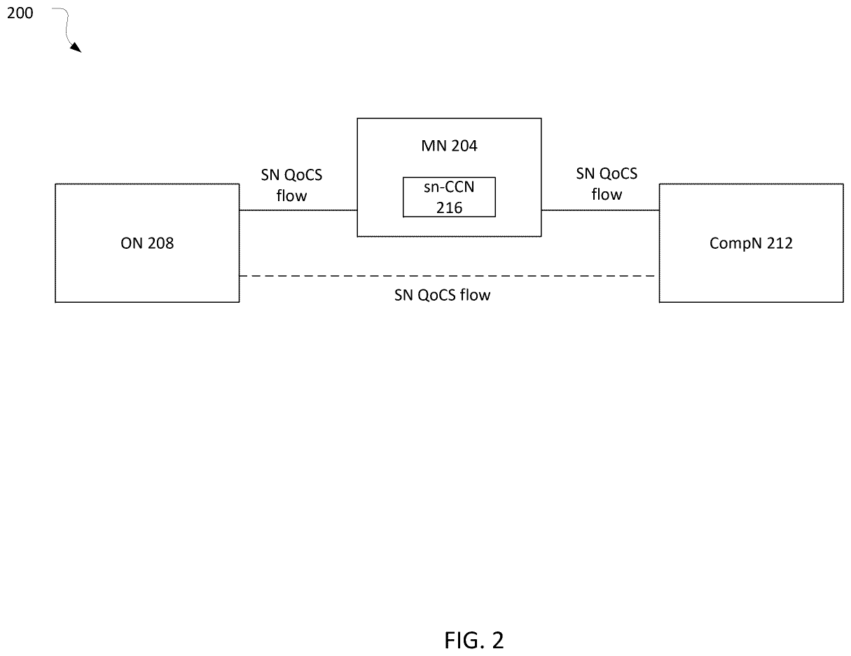

FIG. 2 illustrates an example of compute offloading in a subnetwork 200, in accordance with some embodiments. The subnetwork 200 may correspond to the subnetwork 106. The subnetwork 200 may include an MN 204 (e.g., corresponding to the MN 104), an offloading node (ON) 208, and a computation node (CompN) 212. The MN 204 may correspond to a UE that manages the subnetwork 200. The ON 208 and/or CompN 212 may correspond to respective UEs of the subnetwork 200 (e.g., corresponding to any of UEs 1-4 of FIG. 1).

The ON 208 may have a compute task to be offloaded to the CompN 212. The CompN 212 may perform the offloaded compute task and produce a compute result. A subnetwork compute offload controlling node (sn-CCN) 216 may perform registration, database management, finding resources, and/or other operations to control compute services offloading between the ON 208 and the CompN 212. As shown in FIG. 2, the sn-CCN 216 may be implemented in the MN 204 of the subnetwork 200. In other embodiments, the sn-CCN 216 may be partially or completely implemented in another device (e.g., another UE) of the subnetwork 200.

The sn-CCN 216 may configure a subnetwork (SN) QoCS flow to provide offloading of a compute task from the ON 208 to the CompN 212 in accordance with one or more QoCS characteristics (e.g., of a QoCS profile). As shown, the SN QoCS flow may be routed between the ON 208 and the CompN 212 via the MN 204 (e.g., via a subnetwork user plane (sn-UP) implemented by the MN 204) and/or directly between the ON 208 and the CompN 212.

In various embodiments, the QoCS characteristics may include one or more of the following:
Computation resource type, which may include a guaranteed computation delay (GCD) and/or a non-GCD. The computation resource type may be used to determine if dedicated compute resources are statically allocated to (e.g., reserved for) a flow by an admission control algorithm.
Default (computation) priority level, which may indicate the priority for scheduling compute resources. For example, in case of congestion, the priority level may determine which QoCS flow is prioritized over others. In another example, e.g., when there is no congestion, the priority level may be used to distribute compute resources between different QoCS flows.
Interaction type, which may indicate whether the compute task is iterative or a single shot. In a single shot task, the offloading node may send a workload request and associated information to the computing node and receive a result from the computing node to complete the task. As an example, a photo enhancement may be a single shot task. An iterative task may include multiple iterations of workload information submission and/or result reception until the final result is obtained. As an example, federated learning and/or distributed learning may include multiple iterations. In some embodiments, the interaction type may further indicate a number of iterations associated with the iterative task.
Number of UEs, which may indicate the number of UEs cooperating on the compute task. For example, for a federated learning service, the number of UEs to be selected for local training may be indicated.
Reliability, which may indicate the reliability level required for the compute node to be chosen for the requested compute task. In some embodiments, the reliability may be indicated by a confidence value (e.g., a value between 0 and 1), and/or a qualitative value (e.g., selected from two or more reliability levels, such as high, low, etc.).
Privacy/security, which may indicate a privacy and/or security level required for the compute node to be chosen for the requested compute task. Similar to the reliability level, the privacy/security level may be indicated by a trust value (e.g., a value between 0 and 1) and/or a qualitative value.
Numerical precision, which may indicate a required numerical precision for the compute task.
Delay violation probability/rate, which may indicate a tolerable computation (or computation and communication) delay violation. In some embodiments, the delay violation probability/rate may be a real value between 0 and 1. It may be interpreted as the percentage of the computation results experiencing a delay exceeding the QoCS flow computation delay budget. Accordingly, the offloading node may expect that there is a corresponding percentage chance of delayed results that may have to be discarded.
Default averaging window, which may indicate a time window over which the delay of the computation results (e.g., for iterative workload types) is averaged.

In embodiments, a combination of QoCS characteristics may be mapped to an identifier, referred to as a subnetwork QoCS identifier (SN-QCI). A plurality of SN-QCIs may be predefined with corresponding sets of QoCS characteristics.

A subnetwork QoCS profile may be defined that includes the QoCS characteristics (e.g., for computation aspects of a QoCS flow), QoS characteristics (e.g., for communication aspects of the QoCS flow), and/or other parameters for the QoCS flow. The QoCS profile may be associated with a QoCS flow identifier (SN-CQFI).

For example, the subnetwork QoS profile may include an SN-QCI to indicate a corresponding set of QoCS characteristics, e.g., as described above. The subnetwork QoS profile may further include a subnetwork QoS indicator (SN-QI) to indicate a set of QoS characteristics for communication. For example, the QoS characteristics may include one or more of a resource type, a default priority level, a packet delay budget (PDB), a packet error rate (PER), a default averaging window, and/or a default maximum data burst volume (MDBV).

In some embodiments, if a service does not require computation, a default SN-QCI (e.g., SN-QCI=0) may be configured for a flow. The default SN-QCI may correspond to default values of one or more of the QoCS characteristics and/or may not correspond to specific values of one or more of the QoCS characteristics (e.g., since they are not required for the flow).

The QoCS profile may further include one or more other parameters, such as an allocation and retention priority (ARP), a reflective QoS attribute (RQA), a guaranteed flow bit rate (GFBR) and/or a maximum flow bit rage (MFBR) for uplink and/or downlink, a subnetwork QoS notification control (QNC), and/or a maximum packet loss rate for uplink and/or downlink. Additionally, or alternatively, the QoCS profile may include one or more other computation-related parameters, such as a guaranteed computation delay (GCD, e.g., corresponding to a computation delay guaranteed to be provided by the subnetwork), a computation power (e.g., an estimated power required for the compute task), a subnetwork compute notification control (CNC, e.g., an indication of whether notifications are requested from the MN when the GCD status changes, such as when the GCD can no longer be guaranteed or when the GCD can again be guaranteed, for a GCD QoCS flow), and/or an aggregate bitrate (e.g., the aggregate flow bitrate required for a multi-UE subnetwork QoCS flow). In some embodiments, the one or more other computation-related parameters may be included in the QoCS profile for a GCD QoCS flow (and may not be included for a non-GCD QoCS flow).

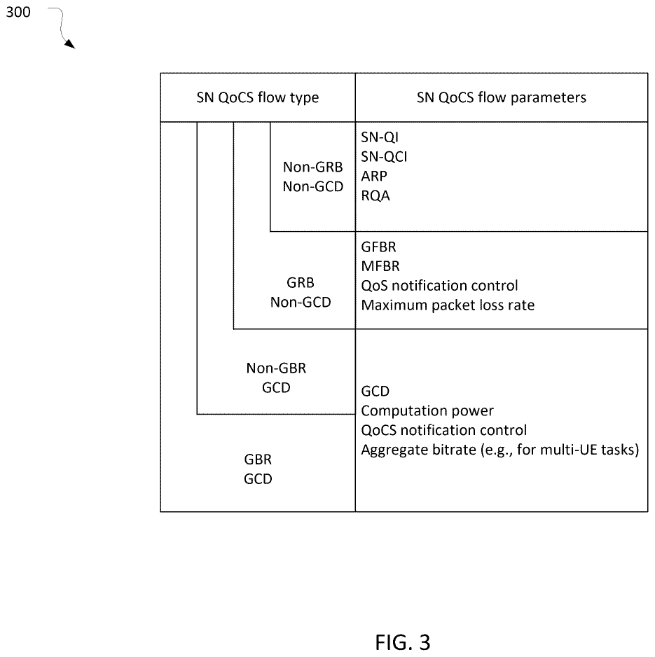

FIG. 3 illustrates an example table 300 of QoCS flow parameters of a QoCS profile that may be configured for different subnetwork QoCS flow types, in accordance with some embodiments. For example, the QoCS flow types may include non-GBR and non-GCD; GBR and non-GCD; non-GBR and GCD; and/or GBR and GCD. The QoCS flow parameters may be associated with an SN-CQFI.

As shown, the QoCS profile for a non-GBR and non-GCD flow type may include the SN-QI, the SN-QCI, the ARP, and/or the RQA. As discussed above, the SN-QI may indicate a set of corresponding QoS parameters and the SN-QCI may indicate a set of corresponding QoCS parameters.

The QoCS profile for a GBR and non-GCD flow type may additionally include (in addition to the parameters of the non-GBR and non-GCD flow type) the GFBR, the MFBR, the QNC, and/or the maximum packet loss rate. The flow types with GCD (e.g., GCD and non-GBR and/or GCD and GBR) may additionally include (in addition to the parameters of the non-GCD flow types) the GCD, computation power, CNC, and/or aggregate bitrate. In some embodiments, one or more of the parameters may be optional, such as the RQA, QNC, maximum packet loss rate, CNC, and/or aggregate bitrate.

In other embodiments, a single indicator, which may be referred to herein as SN-XQCI, may be used to indicate both subnetwork QoS and subnetwork QoCS characteristics. A flow type of QoS or QoCS may be further configured for a service. For example, the type of flow may be determined by a flow type parameter signaled in the subnetwork flow establishment and/or modification procedure.

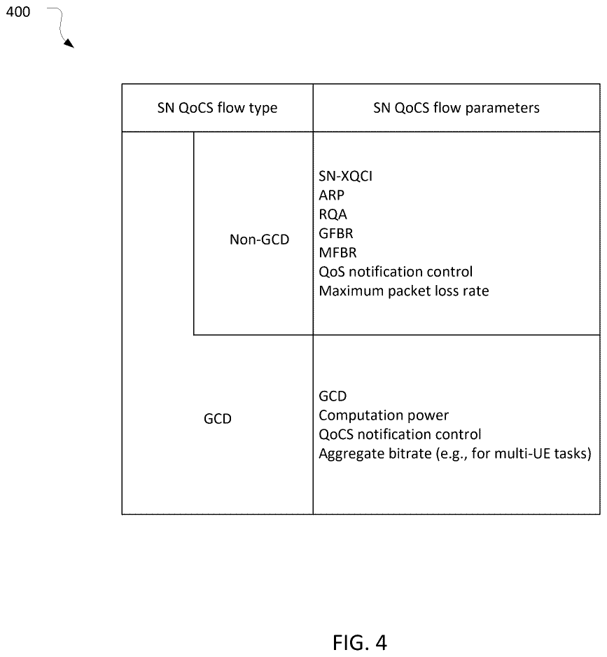

FIG. 4 illustrates an example table 400 of QoCS flow parameters of a QoCS profile for non-GCD and GCD QoCS flow types, in accordance with some embodiments. As shown, the QoCS profile for non-GCD may include the SN-XQCI, ARP, RQA, GFBR, MFBR, QNC, and/or maximum packet loss rate. The QoCS profile for GCD may additionally include the GCD, computation power, CNC, and/or aggregate bitrate. In some embodiments, one or more of the parameters may be optional, such as the RQA, QNC, maximum packet loss rate, CNC, and/or aggregate bitrate.

As discussed above, embodiments herein further provide procedures for compute offloading in one or more subnetworks using QoCS flows, in accordance with some embodiments. For example, the compute offloading may be within a subnetwork or between different subnetworks.

With local subnetwork compute offloading, an ON may offload a compute task to one or more CompNs in the same subnetwork. For example, the one or more CompNs may be included in the MN and/or another UE of the subnetwork. In some embodiments, the overlay network may not be involved in the compute offloading.

In some embodiments, the sn-CCN of the local MN may be assumed as the default compute offload controlling entity, e.g., without involvement from other CCN entities of the network or subnetwork. The sn-CCN may create subnetwork QoCS rules and/or profiles, and establish one or more SN QoCS flows between the ON and the CompN. The one or more SN QoCS flows may be via the MN that includes the sn-CCN and/or directly between the ON and the CompN.

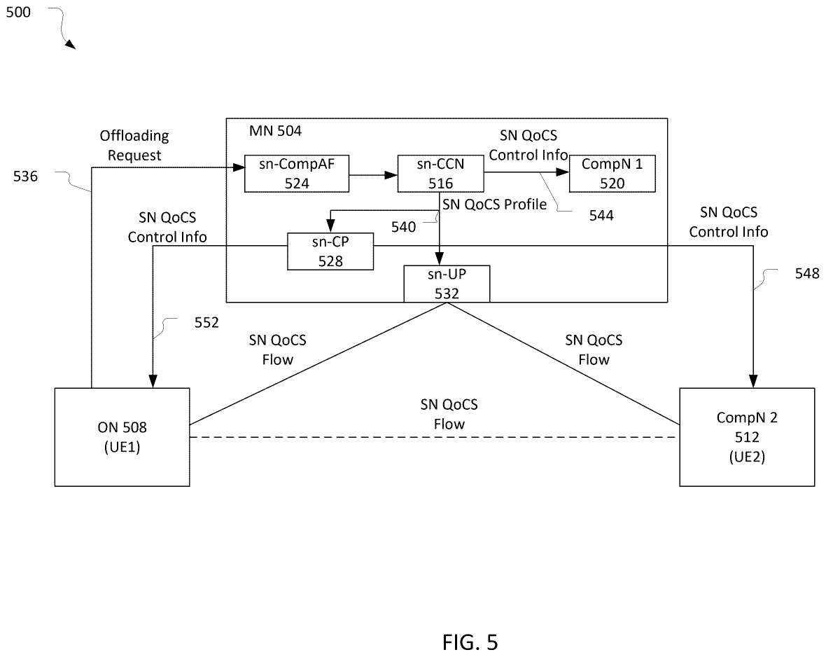

FIG. 5 illustrates an example of local subnetwork compute offloading in a subnetwork 500, in accordance with some embodiments. The subnetwork 500 may include an MN 504, an ON 508, and a CompN 512, which may correspond to respective UEs and/or applications associated with the subnetwork 500. The MN 504 may implement an sn-CCN 516, a CompN 520, a subnetwork compute application function (sn-CompAF) 524, a subnetwork control plane (sn-CP) 528, and/or a subnetwork user plane (sn-UP) 532. In the example of FIG. 5, the ON 508 may offload a compute task to the CompN 520 of the MN 504 and the CompN 512 of another UE.

As illustrated at 536, the ON 508 may send an offloading request to the sn-CCN 516. For example, the offloading request may be transmitted to the sn-CCN 516 via application layer signaling (e.g., via the sn-CompAF 524). The request may indicate a UE ID associated with the ON 508, a compute task request (e.g., with information about the compute task), a service data flow (SDF) description, a bandwidth requirement, and/or other computing service requirements associated with the compute task to be offloaded.

The sn-CCN 516 may identify and/or allocate one or more CompNs (e.g., the CompN 512 and CompN 520) for the compute task based on the offloading request. For example, one or more CompNs may be selected based on CompN information for respective CompNs associated with the subnetwork 500. The CompN information may be received from the respective CompNs and/or stored by the sn-CCN 516. For example, the CompN information may include capability information, a CompN ID, a capacity, a location, a mobility status, an address, and/or a resource status (such as available or not available).

The sn-CCN 516 may generate QoCS parameters (e.g., compute and/or communication requirements) of a subnetwork QoCS profile and send the QoCS profile to the sn-CP 528 and/or sn-UP 532 (e.g., illustrated at 540).

The sn-CCN 516 may send subnetwork QoSC control information to the CompN(s) selected for the compute offloading and/or to the ON 508. The QoSC control information may indicate one or more QoCS rules for a QoCS flow. For example, the QoCS control information may include a subnetwork QoCS indicator (e.g., an sn-QCI and/or SN-CQFI), a CompN ID of the CompN, and an ON ID of the ON 508).

For example, illustrated at 544, the sn-CCN 516 may send the subnetwork QoCS control information (info) to the CompN 520 of the MN 504. At 548, the sn-CCN 516 may send the subnetwork QoCS control information to the CompN 512 via the sn-CP 528. At 552, the sn-CCN 516 may send the subnetwork QoCS control information to the ON 508 via the sn-CP 528.

The ON 508 may establish an SN-QoCS flow with the CompN 512 and/or CompN 520 based on the subnetwork QoCS control information. The SN-QoCS flows may be via the sn-UP 532 and/or directly between the ON 504 and the respective CompN. The sn-UP 532 may process the SN-QoCS flow in accordance with the QoCS profile configured by the sn-CCN 516.

In some embodiments, compute offloading across different subnetworks (e.g., referred to as distributed compute offloading) may be supported. For example, an ON may offload a compute task to any available CompN(s) (e.g., of neighboring SN(s), base station(s), core network(s), cloud server(s), etc.). In some embodiments, the sn-CCNs of different subnetworks may perform a negotiation procedure among themselves and select a managing CCN (m-CCN). The other sn-CCNs may act as supporting CCNs (s-CCNs). The sn-CCN in each subnetwork may be responsible for mapping the compute request received from an ON to one or more CompNs, e.g., based on session management subscription information and/or CompN capability information. If there is no CompN within the SN that can support the requested compute workload, the sn-CCN may route the request to the m-CCN. The overlay network may or may not provide communication support for the subnetworks.

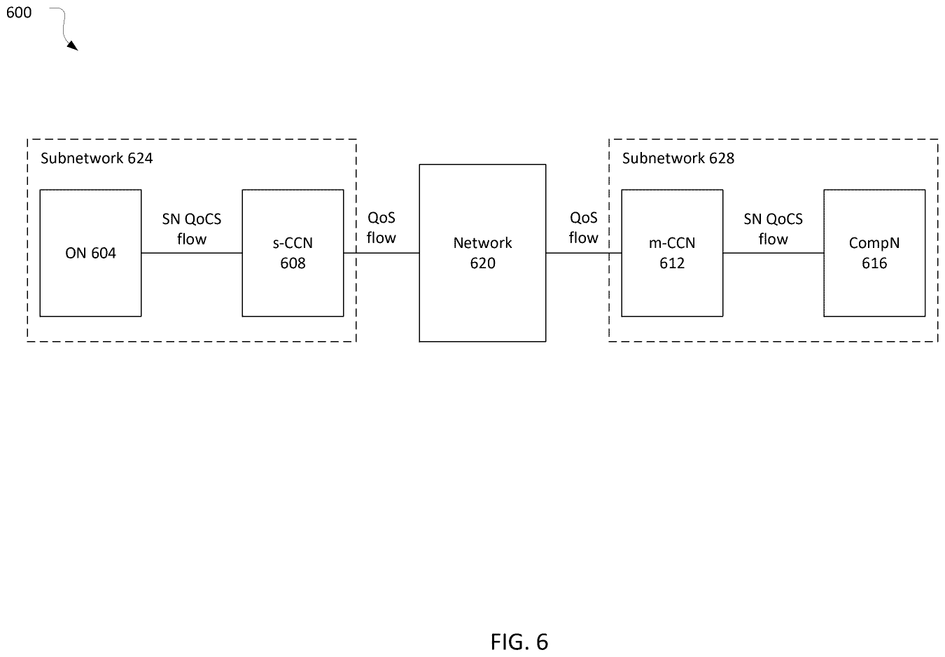

FIG. 6 illustrates an example of a network environment 600 for distributed compute offloading in which the compute offloading traffic may be routed via the overlay network, in accordance with some embodiments. For example, the network environment 600 may include an ON 604, an s-CCN 608, an m-CCN 612, a CompN 616, and a network 620 (e.g., a cellular network such as network 114). The ON 604 and s-CCN 608 may be included in a first subnetwork 624 and the m-CCN 612 and the CompN 616 may be associated with a second subnetwork 628. In other embodiments, the m-CCN may be in the same subnetwork as the ON. In that case, the sn-CCN of the subnetwork that includes the CompN may act as an s-CCN.

The network 620 may provide communication resources for the offloading of a compute task from the ON 604 to the CompN 616. The CCN of the network 620 may not be triggered by the compute offloading procedure. To use the communication resources of the network 620, the first subnetwork 624 and/or second subnetwork 628 may need to register with the network 620. For example, the m-CCN 612 may send a request to the network 616 to request availability information for communication resources.

The m-CCN 612 may create one or more SN QoCS rules and/or profiles for a subnetwork QoCS flow between the ON 604 and the s-CCN 608 and between the m-CCN 612 and the CompN 616. The m-CCN 612 may further send a request to the network 620 to reserve communication resources of the network 620. The network 620 may establish a QoS flow for communication between the s-CCN 608 and the m-CCN 612 via the network 620.

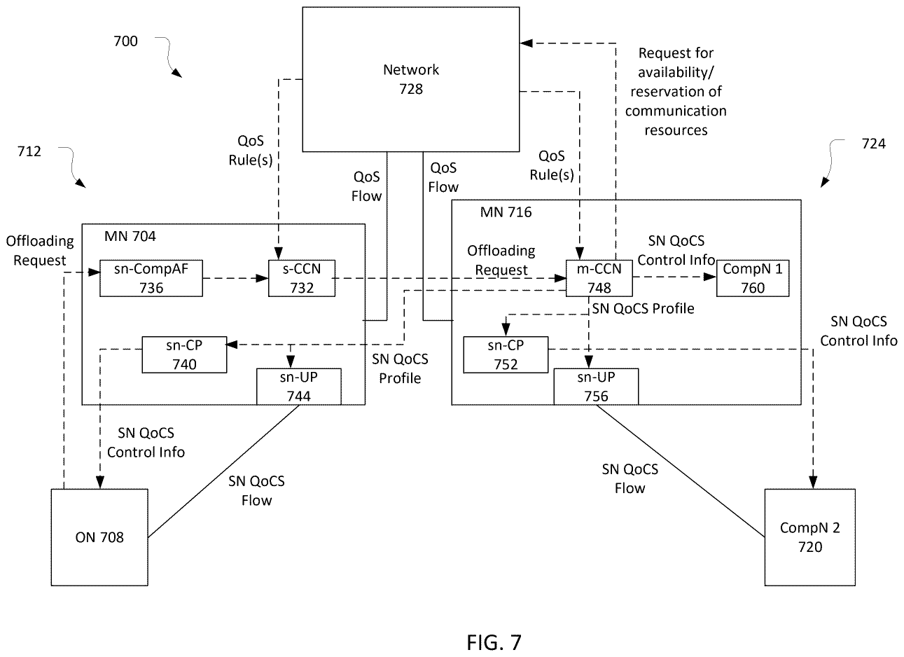

FIG. 7 illustrates an example network environment 700 for decentralized compute offloading between subnetworks using network communication resources, in accordance with some embodiments. The network environment 700 may illustrate an example implementation of the network environment 600 illustrated in FIG. 6.

For example, the network environment 700 may include an MN 704 and an ON 708 of a first subnetwork 712. The network environment 700 may further include an MN 716 and a CompN 720 of a second subnetwork 724. The MN 704 and MN 716 may have a communication link with a network 728. The network 728 may be a cellular network, e.g., including one or more base stations and/or a core network.

The MN 704 may implement an s-CCN 732, an sn-CompAF 736, an sn-CP 740, and/or an sn-UP 744. The MN 716 may implement an m-CCN 748, an sn-CP 752, and/or an sn-UP 756. In some embodiments, the MN 716 may further implement a CompN 760 to which some or all of a compute task may be offloaded.

The ON 708 may send an offloading request to the s-CCN 732 of its subnetwork 712. The offloading request may be transmitted via application layer signaling (e.g., via the sn-CompAF 736). The request may indicate a UE ID associated with the ON 708, a compute task request (e.g., with information about the compute task), an SDF description, a bandwidth requirement, and/or other computing service requirements associated with the compute task to be offloaded.

The s-CCN 732 may forward the offloading request to the m-CCN 748. In some embodiments, the offloading request may be forwarded via the network 728 and/or via a direct communication link between the subnetworks 712 and 724. The m-CCN 748 may identify and/or allocate one or more CompNs (e.g., the CompN 720 and/or CompN 760) for the compute task based on the offloading request. For example, one or more CompNs may be selected based on CompN information for respective CompNs available to the m-CCN 748. The CompN information may include capability information, a CompN ID, a capacity, a location, a mobility status, an address, and/or a resource status (such as available or not available). The m-CCN 748 may further send a request to the network 728 for availability information associated with network resources.

The m-CCN 748 may generate QoCS parameters (e.g., compute and/or communication requirements) of a subnetwork QoCS profile. Additionally, the m-CCN 748 may send the QoCS profile to the sn-CP 740, sn-UP 744, sn-CP 752, and/or sn-UP 756.

The m-CCN 748 may send subnetwork QoSC control information (e.g., to indicate one or more QoCS rules) to the CompN(s) selected for the compute offloading (e.g., CompN 720 and/or 760) and/or to the ON 708. The QoSC control information may include a subnetwork QoCS indicator (e.g., an sn-QCI or SN-CQFI), a CompN ID of the CompN, and an ON ID of the ON 708).

For example, the m-CCN 748 may send the subnetwork QoCS control information to the CompN 720 of the MN 716 directly (e.g., without routing it through the sn-CP 752 since they are both implemented in MN 716). The m-CCN 748 may send the subnetwork QoCS control information to the CompN 760 and/or the ON 708 via the sn-CP 752.

The m-CCN 748 may further transmit a request to the network 728 to reserve communication resources for the compute offload. The network 728 may establish a QoS flow between the network 728 and the m-CCN 748 and between the network 728 and the s-CCN 732. For example, the network 728 may send one or more QoS rules to the s-CCN 732 (e.g., to the MN 704) and/or the m-CCN 748 (e.g., to the MN 716) to configure the QoS flow.

The s-CCN 732 may establish an SN-QoCS flow between the ON 708 and the MN 704 (e.g., via the sn-UP 744) based on the subnetwork QoCS control information. Additionally, the m-CCN 748 may establish an SN-QoCS flow between the MN 716 and the respective CompNs 720 and/or 760 (e.g., via the sn-UP 756) based on the subnetwork QoCS control information. The sn-UP 744 and/or sn-UP 756 may process the SN-QoCS flows in accordance with the QoCS profile configured by the m-CCN 748.

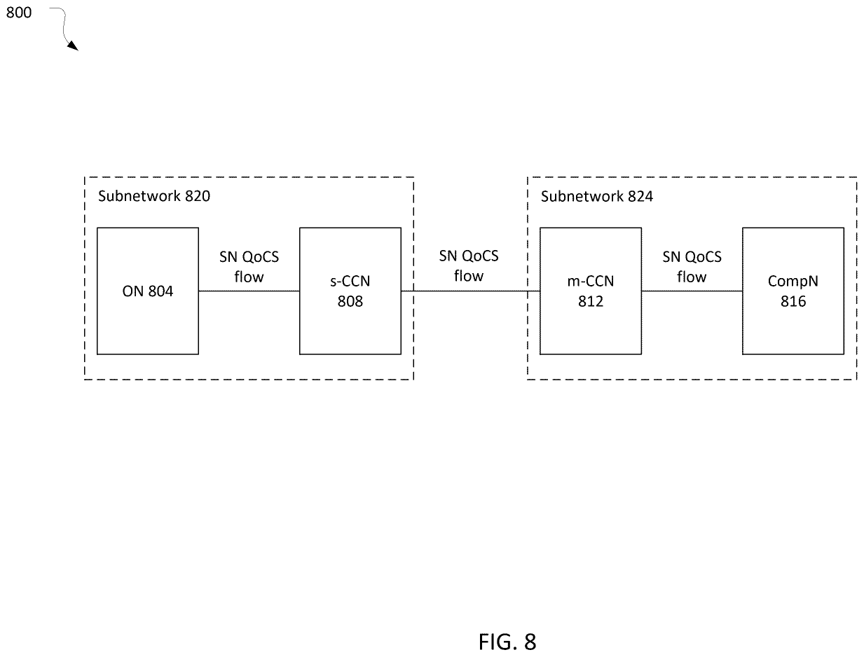

FIG. 8 illustrates an example of a network environment 800 for distributed compute offloading in which the compute offloading traffic may be routed via direct communication between different subnetworks, in accordance with some embodiments. For example, the network environment 800 may include an ON 804, an s-CCN 808, an m-CCN 812, and a CompN 816. The ON 804 and s-CCN 808 may be included in a first subnetwork 820 and the m-CCN 812 and the CompN 816 may be associated with a second subnetwork 828. In other embodiments, the m-CCN may be in the same subnetwork as the ON. In that case, the sn-CCN of the subnetwork that includes the CompN may act as an s-CCN.

The m-CCN 812 may establish an SN QoCS flows between the ON 804 and the CompN 816 via the s-CCN 808 and the m-CCN 812. The SN QoCS flows may include a direct communication link (SN QoCS flow) between the s-CCN 808 of the first subnetwork 820 and the m-CCN 812 of the second subnetwork 824. The m-CCN 812 may determine one or more SN QoCS rules and/or profiles for the SN QoCS flows.

Accordingly, the compute offloading of a compute task from the ON 804 to the CompN 816 may be performed without network involvement (e.g., in communication and/or computation resources). In an example, the direct communication of FIG. 8 may be used when the subnetwork 820 and the subnetwork 824 are in a same geographical area (e.g., in relatively close physical proximity to enable the direct communication). In another example, the direct communication may be used based on the network indicating that network communication resources are unavailable to use for the subnetwork compute offloading.

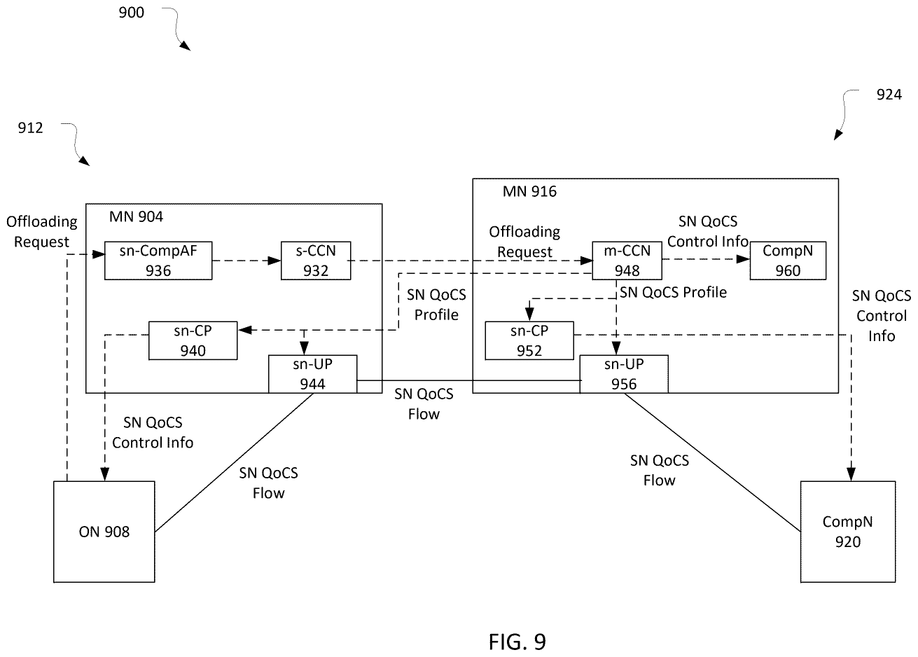

FIG. 9 illustrates an example network environment 900 for distributed compute offloading between subnetworks using direct communication between the subnetworks, in accordance with some embodiments. The network environment 900 may illustrate an example implementation of the network environment 800 illustrated in FIG. 8.

For example, the network environment 900 may include an MN 904 and an ON 908 of a first subnetwork 912. The network environment 900 may further include an MN 916 and a CompN 920 of a second subnetwork 924. The MN 904 may implement an s-CCN 932, an sn-CompAF 936, an sn-CP 940, and/or an sn-UP 944. The MN 916 may implement an m-CCN 948, an sn-CP 952, and/or an sn-UP 956. In some embodiments, the MN 916 may further implement a CompN 960 to which some or all of a compute task may be offloaded from the ON 908.

The ON 908 may send an offloading request to the s-CCN 932 of its subnetwork 912. The offloading request may be transmitted via application layer signaling (e.g., via the sn-CompAF 936). The request may indicate a UE ID associated with the ON 908, a compute task request (e.g., with information about the compute task), an SDF description, a bandwidth requirement, and/or other computing service requirements associated with the compute task to be offloaded.

The s-CCN 932 may forward the offloading request to the m-CCN 948. For example, the offloading request may be forwarded via a direct communication link between the subnetworks 912 and 924. The m-CCN 948 may identify and/or allocate one or more CompNs (e.g., the CompN 920 and/or CompN 960) for the compute task based on the offloading request. For example, one or more CompNs may be selected based on CompN information for respective CompNs available to the m-CCN 948. The CompN information may include capability information, a CompN ID, a capacity, a location, a mobility status, an address, and/or a resource status (such as available or not available).

The m-CCN 948 may generate QoCS parameters (e.g., compute and/or communication requirements) of a subnetwork QoCS profile. Additionally, the m-CCN 948 may send the QoCS profile to the sn-CP 940, sn-UP 944, sn-CP 952, and/or sn-UP 956.

The m-CCN 948 may send subnetwork QoSC control information (e.g., to indicate one or more QoCS rules) to the CompN(s) selected for the compute offloading (e.g., CompN 920 and/or 960) and/or to the ON 908. The QoSC control information may include a subnetwork QoCS indicator (e.g., an sn-QCI or SN-CQFI), a CompN ID of the CompN, and an ON ID of the ON 908).

For example, the m-CCN 948 may send the subnetwork QoCS control information to the CompN 920 of the MN 916 directly (e.g., without routing it through the sn-CP 952 since they are both implemented in MN 916). The m-CCN 948 may send the subnetwork QoCS control information to the CompN 960 and/or the ON 908 via the sn-CP 952.

The m-CCN 948 may further establish a QoCS flow between the m-CCN 948 and the s-CCN 932. For example, the network 928 may send one or more QoS rules to the s-CCN 932 to configure the QoS flow. Additionally, the m-CCN 948 may establish an SN-QoCS flow between the MN 916 and the respective CompNs 920 and/or 960 (e.g., via the sn-UP 956) based on the subnetwork QoCS control information. The sn-UP 944 and/or sn-UP 956 may process the SN-QoCS flows in accordance with the QoCS profile configured by the m-CCN 948.

The s-CCN 932 may establish an SN-QoCS flow between the ON 908 and the MN 904 (e.g., via the sn-UP 944) based on the subnetwork QoCS control information. Accordingly, the compute offloading from the ON 908 and CompNs 920 and/or 960 may be performed (e.g., including communication of the compute offloading request and compute results) via the QoCS flows between the ON 908 and CompNs 920 and/or 960 via the MN 904 and MN 916.

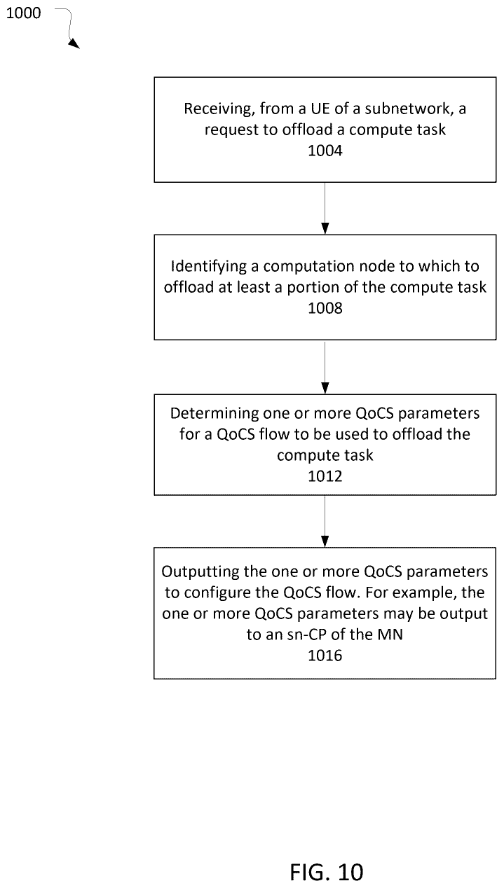

FIG. 10 illustrates an operational flow/algorithmic structure 1000 in accordance with some embodiments. In some embodiments, the operational flow/algorithmic structure 1000 may be implemented by a UE such as, for example, MN 104, another UE of subnetwork 106, UE 1300, another UE herein, and/or or components thereof, for example, processors 1304A. For example, the operational flow/algorithmic structure 1000 may be implemented by a UE that implements a CCN of a subnetwork, which may be the MN or another UE of the subnetwork.

The operational flow/algorithmic structure 1000 may include, at 1004, receiving, from a UE of a subnetwork, a request to offload a compute task. The request may include, for example, a UE ID associated with the ON, information about the compute task (e.g., an SDF description), a bandwidth requirement, and/or other computing service requirements associated with the compute task to be offloaded.

The operational flow/algorithmic structure 1000 may further include, at 1008, identifying a computation node to which to offload at least a portion of the compute task. For example, the computation node may be associated with the subnetwork, another subnetwork, and/or a cellular network (e.g., associated with a base station and/or a core network of the cellular network).

The operational flow/algorithmic structure 1000 may further include, at 1012, determining one or more QoCS parameters for a QoCS flow to be used to offload the compute task. For example, the one or more QoCS parameters may include one or more of a computation resource type (e.g., indicating a GCD type or a non-GCD type); a computation priority level; an indication of an interaction type being a single shot interaction or an iterative interaction; a number of UEs to cooperate on the compute task; a reliability level for the compute task; a security level for the compute task; a numerical precision for the compute task; a delay violation probability or rate; and/or a default averaging window. In embodiments, for a GCD computation resource type, the one or more QoCS parameters may further include one or more of a computation power; a subnetwork compute notification control indicator to indicate whether a notification is requested when the GCD can no longer be guaranteed; and/or an aggregate bitrate required for the QoCS flow (e.g., for a QoCS flow that includes multiple UEs).

The operational flow/algorithmic structure 1000 may further include, at 1016, outputting the one or more QoCS parameters to configure the QoCS flow. For example, the one or more QoCS parameters may be output to an sn-CP of the MN. The sn-CP may send QoCS control information to the ON and/or the computation node to configure the QoCS flow based on the one or more QoCS parameters. In some embodiments, outputting the one or more QoCS parameters includes outputting a subnetwork QoCS identifier to indicate the one or more QoCS parameters. The CCN may further output a separate QoS identifier to indicate one or more QoS characteristics for communication associated with offloading the compute task. In other embodiments, outputting the one or more QoCS parameters includes outputting a joint indicator to indicate the one or more QoCS parameters and one or more QoS characteristics for communication associated with offloading the compute task.

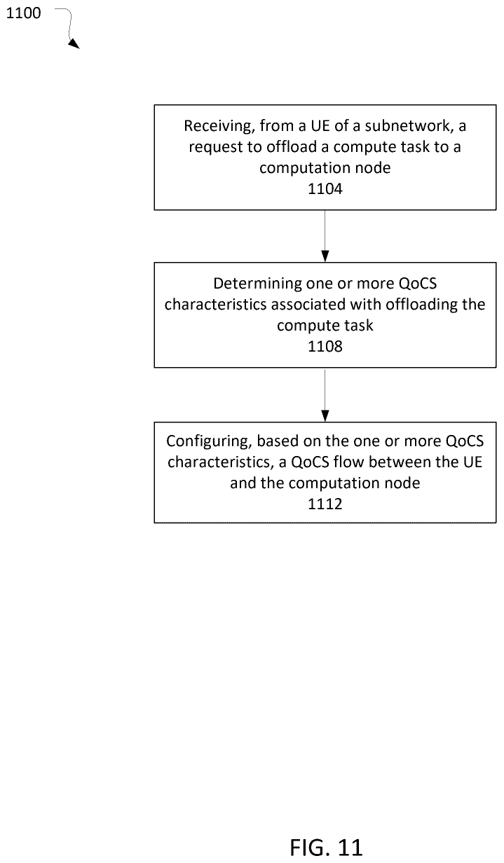

FIG. 11 illustrates another operational flow/algorithmic structure 1100 in accordance with some embodiments. In some embodiments, the operational flow/algorithmic structure 1100 may be implemented by a UE such as, for example, MN 104, another UE of subnetwork 106, UE 1300, another UE herein, and/or or components thereof, for example, processors 1304A. For example, the operational flow/algorithmic structure 1000 may be implemented by a UE that implements a CCN of a subnetwork, which may be the MN or another UE of the subnetwork.

The operational flow/algorithmic structure 1100 may include, at 1104, receiving, from a UE of a subnetwork, a request to offload a compute task to a computation node. The request may include, for example, a UE ID associated with the ON, information about the compute task (e.g., an SDF description), a bandwidth requirement, and/or other computing service requirements associated with the compute task to be offloaded.

The operational flow/algorithmic structure 1100 may further include, at 1108, determining one or more QoCS characteristics associated with offloading the compute task. For example, the one or more QoCS characteristics may include one or more of a computation resource type (e.g., indicating a GCD type or a non-GCD type); a computation priority level; an indication of an interaction type being a single shot interaction or an iterative interaction; a number of UEs to cooperate on the compute task; a reliability level for the compute task; a security level for the compute task; a numerical precision for the compute task; a delay violation probability or rate; and/or a default averaging window. In embodiments, for a GCD computation resource type, the one or more QoCS characteristics may further include one or more of a computation power; a subnetwork compute notification control indicator to indicate whether a notification is requested when the GCD can no longer be guaranteed; and/or an aggregate bitrate required for the QoCS flow (e.g., for a QoCS flow that includes multiple UEs).

The operational flow/algorithmic structure 1100 may further include, at 1112, configuring, based on the one or more QoCS characteristics, a QoCS flow between the UE and the computation node. For example, configuring the QoCS flow may include generating a message, for transmission to the UE and/or the computation node to indicate the one or more QoCS characteristics. For example, the message may be transmitted via an sn-CP of the MN. In some embodiments, the message may include a subnetwork QoCS identifier to indicate the one or more QoCS characteristics. The message may further include a separate QoS identifier to indicate one or more QoS characteristics for communication associated with offloading the compute task. In other embodiments, the message may include a joint indicator to indicate the one or more QoCS characteristics and one or more QoS characteristics for communication associated with offloading the compute task.

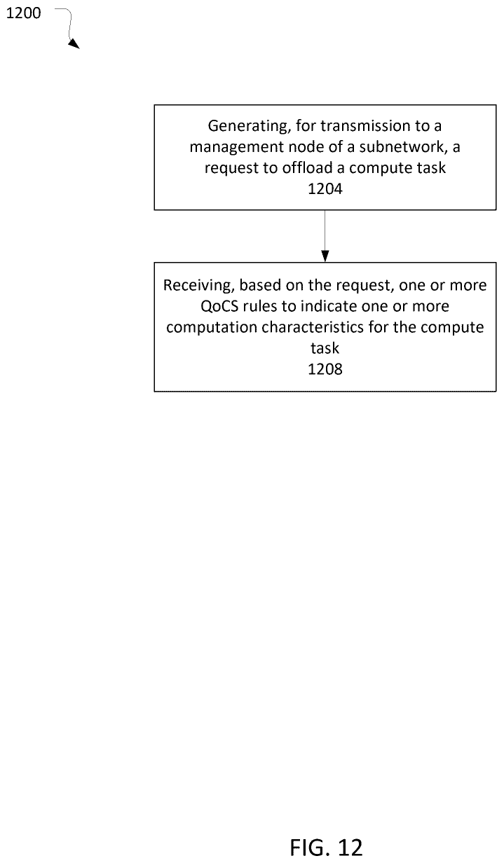

FIG. 12 illustrates another operational flow/algorithmic structure 1200 in accordance with some embodiments. The operational flow/algorithmic structure 1200 may be implemented by a UE that corresponds to an ON of a subnetwork (e.g., that has a compute task to offload), for example, MN 104, another UE of subnetwork 106, UE 1300, another UE herein, and/or or components thereof, for example, processors 1304A.

The operational flow/algorithmic structure 1200 may include, at 1204, generating, for transmission to a management node of a subnetwork, a request to offload a compute task. The request may include, for example, a UE ID associated with the ON, information about the compute task (e.g., an SDF description), a bandwidth requirement, and/or other computing service requirements associated with the compute task to be offloaded.

The operational flow/algorithmic structure 1200 may further include, at 1208, receiving, based on the request, one or more QoCS rules to indicate one or more computation characteristics for the compute task. For example, the one or more computation characteristics may include one or more of a computation resource type (e.g., indicating a GCD type or a non-GCD type); a computation priority level; an indication of an interaction type being a single shot interaction or an iterative interaction; a number of UEs to cooperate on the compute task; a reliability level for the compute task; a security level for the compute task; a numerical precision for the compute task; a delay violation probability or rate; and/or a default averaging window. In embodiments, for a GCD computation resource type, the one or more computation characteristics may further include one or more of a computation power; a subnetwork compute notification control indicator to indicate whether a notification is requested when the GCD can no longer be guaranteed; and/or an aggregate bitrate required for the QoCS flow (e.g., for a QoCS flow that includes multiple UEs). In some embodiments, the one or more QoCS rules may include a subnetwork QoCS identifier to indicate the one or more computation characteristics. In some embodiments, the one or more QoCS rules further include an ID of a computation node to which the compute task is to be offloaded. In some embodiments, the one or more QoCS rules may further indicate one or more QoS characteristics for communication associated with offloading the compute task. The QoS characteristics may be indicated by a separate QoS identifier or jointly indicated by the QoCS identifier.

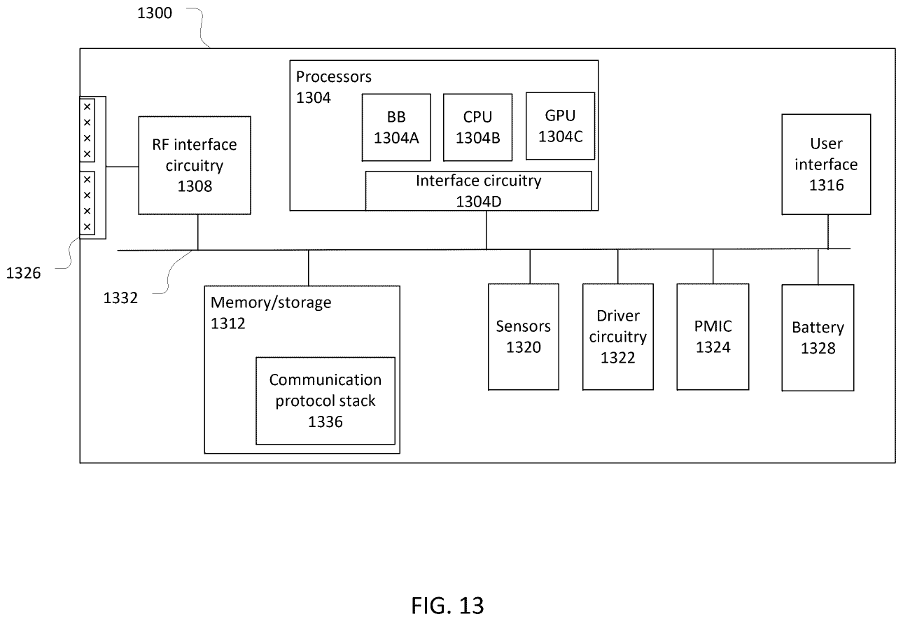

FIG. 13 illustrates a UE 1300 in accordance with some embodiments. The UE 1300 may be similar to and substantially interchangeable with UE 104, another UE of subnetwork 106, and/or another UE described herein (e.g., an ON, MN, CCN, and/or CompN as described herein).

The UE 1300 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 1300 may include processors 1304, RF interface circuitry 1308, memory/storage 1312, user interface 1316, sensors 1320, driver circuitry 1322, power management integrated circuit (PMIC) 1324, antenna 1326, and battery 1328. The components of the UE 1300 may be implemented as integrated circuits (ICs), portions thereof, discrete electronic devices, or other modules, logic, hardware, software, firmware, or a combination thereof. The block diagram of FIG. 13 is intended to show a high-level view of some of the components of the UE 1300. However, some of the components shown may be omitted, additional components may be present, and different arrangement of the components shown may occur in other implementations.

The components of the UE 1300 may be coupled with various other components over one or more interconnects 1332, which may represent any type of interface, input/output, bus (local, system, or expansion), transmission line, trace, or optical connection that allows various circuit components (on common or different chips or chipsets) to interact with one another.

The processors 1304 may include processor circuitry such as, for example, baseband processor circuitry (BB) 1304A, central processor unit circuitry (CPU) 1304B, and graphics processor unit circuitry (GPU) 1304C. The processors 1304 may include any type of circuitry or processor circuitry that executes or otherwise operates computer-executable instructions, such as program code, software modules, or functional processes from memory/storage 1312 to cause the UE 1300 to perform operations as described herein (e.g., operations associated with offloading a compute task from a UE of a subnetwork). The processors 1304 may also include interface circuitry 1304D to enable communication by, for example, communicatively coupling the processor circuitry with one or more other components of the UE 1300.

In some embodiments, the baseband processor 1304A may access a communication protocol stack 1336 in the memory/storage 1312 to communicate over a 3GPP compatible network. In general, the baseband processor 1304A may access the communication protocol stack 1336 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1308.

The baseband processor 1304A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1312 may include one or more non-transitory, computer-readable media that includes instructions (for example, communication protocol stack 1336) that may be executed by one or more of the processors 1304 to cause the UE 1300 to perform operations as described herein (e.g., operations associated with offloading a compute task from a UE of a subnetwork).

The memory/storage 1312 includes any type of volatile or non-volatile memory that may be distributed throughout the UE 1300. In some embodiments, some of the memory/storage 1312 may be located on the processors 1304 themselves (for example, memory/storage 1312 may be part of a chipset that corresponds to the baseband processor 1304A), while other memory/storage 1312 is external to the processors 1304 but accessible thereto via a memory interface. The memory/storage 1312 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1308 may include transceiver circuitry and a radio frequency front module (RFEM) that allows the UE 1300 to communicate with other devices over a radio access network. The RF interface circuitry 1308 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1326 and proceed to filter and amplify (with a low-noise amplifier) the signal. The signal may be provided to a receiver of the transceiver that down-converts the RF signal into a baseband signal that is provided to the baseband processor of the processors 1304.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1326.

In various embodiments, the RF interface circuitry 1308 may be configured to transmit/receive signals in a manner compatible with NR access technologies.

The antenna 1326 may include antenna elements to convert electrical signals into radio waves to travel through the air and to convert received radio waves into electrical signals. The antenna elements may be arranged into one or more antenna panels. The antenna 1326 may have antenna panels that are omnidirectional, directional, or a combination thereof to enable beamforming and multiple input, multiple output communications. The antenna 1326 may include microstrip antennas, printed antennas fabricated on the surface of one or more printed circuit boards, patch antennas, or phased array antennas. The antenna 1326 may have one or more panels designed for specific frequency bands including bands in FR1 or FR2.

The user interface 1316 includes various input/output (I/O) devices designed to enable user interaction with the UE 1300. The user interface 1316 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1300.

The sensors 1320 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1322 may include software and hardware elements that operate to control particular devices that are embedded in the UE 1300, attached to the UE 1300, or otherwise communicatively coupled with the UE 1300. The driver circuitry 1322 may include individual drivers allowing other components to interact with or control various input/output (I/O) devices that may be present within, or connected to, the UE 1300. For example, driver circuitry 1322 may include a display driver to control and allow access to a display device, a touchscreen driver to control and allow access to a touchscreen interface, sensor drivers to obtain sensor readings of sensors 1320 and control and allow access to sensors 1320, drivers to obtain actuator positions of electro-mechanic components or control and allow access to the electro-mechanic components, a camera driver to control and allow access to an embedded image capture device, audio drivers to control and allow access to one or more audio devices.

The PMIC 1324 may manage power provided to various components of the UE 1300. In particular, with respect to the processors 1304, the PMIC 1324 may control power-source selection, voltage scaling, battery charging, or DC-to-DC conversion.

A battery 1328 may power the UE 1300, although in some examples the UE 1300 may be mounted deployed in a fixed location and may have a power supply coupled to an electrical grid. The battery 1328 may be a lithium ion battery, a metal-air battery, such as a zinc-air battery, an aluminum-air battery, a lithium-air battery, and the like. In some implementations, such as in vehicle-based applications, the battery 1328 may be a typical lead-acid automotive battery.

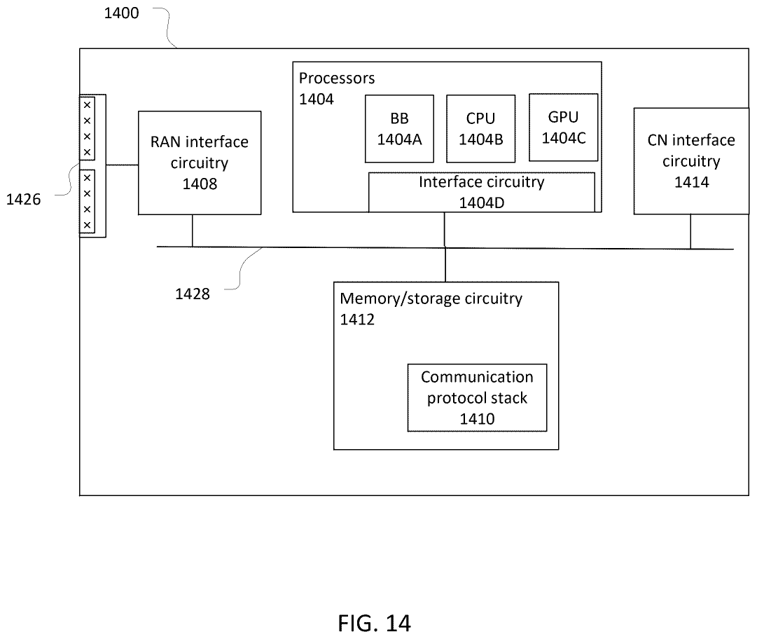

FIG. 14 illustrates a network device 1400 in accordance with some embodiments. The network device 1400 may be similar to, and substantially interchangeable with, the base station 108 and/or a component of the CN 112.

The network device 1400 may include processors 1404, RF interface circuitry 1408 (if implemented as a base station), core network (CN) interface circuitry 1414, memory/storage circuitry 1412, and antenna structure 1426.

The components of the network device 1400 may be coupled with various other components over one or more interconnects 1428.

The processors 1404, RF interface circuitry 1408, memory/storage circuitry 1412 (including communication protocol stack 1410), antenna structure 1426, and interconnects 1428 may be similar to like-named elements shown and described with respect to FIG. 13.

The processors 1404 may include processor circuitry such as, for example, baseband processor circuitry (BB) 1404A, central processor unit circuitry (CPU) 1404B, and graphics processor unit circuitry (GPU) 1404C. The processors 1404 may include any type of circuitry or processor circuitry that executes or otherwise operates computer-executable instructions, such as program code, software modules, or functional processes from memory/storage circuitry 1412 to cause the network device 1400 to perform operations as described herein (e.g., operations associated with offloading a compute task from a UE of a subnetwork). The processors 1404 may also include interface circuitry 1404D to communicatively couple the processor circuitry with one or more other components of the network device 1400.

The CN interface circuitry 1414 may provide connectivity to a core network, for example, a 5^{th} Generation Core network (5GC) using a 5GC-compatible network interface protocol such as carrier Ethernet protocols, or some other suitable protocol. Network connectivity may be provided to/from the network device 1400 via a fiber optic or wireless backhaul. The CN interface circuitry 1414 may include one or more dedicated processors or FPGAs to communicate using one or more of the aforementioned protocols. In some implementations, the CN interface circuitry 1414 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### Examples

The following sections provide further exemplary embodiments are provided.

Example 1 includes a method comprising: receiving, from a user equipment (UE) of a subnetwork, a request to offload a compute task; identifying a computation node to which to offload at least a portion of the compute task, wherein the computation node is associated with the subnetwork or another subnetwork; determining one or more quality of computing services (QoCS) parameters for a QoCS flow to be used to offload the compute task; and outputting the one or more QoCS parameters to configure the QoCS flow.

Example 2 includes the method of example 1 or some other example herein, wherein outputting the one or more QoS parameters to configure the QoCS flow includes outputting the one or more QoCS parameters to a subnetwork control plane (sn-CP), wherein the sn-CP is to send QoCS control information to the UE and the computation node to configure the QoCS flow based on the one or more QoCS parameters.

Example 3 includes the method of example 1 or some other example herein, wherein the one or more QoCS parameters include an indication of a computation resource type being a guaranteed computation delay (GCD) type or a non-GCD type.

Example 4 includes the method of example 3 or some other example herein, wherein the computation resource type is the GCD type, and wherein the one or more QoCS parameters further include one or more of: a computation power; a subnetwork compute notification control indicator to indicate whether a notification is requested when the GCD can no longer be guaranteed; or an aggregate bitrate required for the QoCS flow, wherein the QoCS flow includes multiple UEs.

Example 5 includes the method of example 1 or some other example herein, wherein the one or more QoCS parameters include one or more of: a computation priority level; an indication of an interaction type being a single shot interaction or an iterative interaction; a number of UEs to cooperate on the compute task; a reliability level for the compute task; a security level for the compute task; a numerical precision for the compute task; a delay violation probability or rate; or a default averaging window.

Example 6 includes the method of example 1 or some other example herein, wherein outputting the one or more QoCS parameters includes outputting a subnetwork QoCS identifier to indicate the one or more QoCS parameters, and wherein the method further comprises outputting a quality of service (QoS) identifier to indicate one or more QoS characteristics for communication associated with offloading the compute task.

Example 7 includes the method of example 1 or some other example herein, wherein outputting the one or more QoCS parameters includes outputting a joint indicator to indicate the one or more QoCS parameters and one or more quality of service (QoS) characteristics for communication associated with offloading the compute task.

Example 8 includes the method of example 1 or some other example herein, wherein the computation node is another UE of the subnetwork.

Example 9 includes the method of example 1 or some other example herein, wherein the subnetwork is a first subnetwork, the another subnetwork is a second subnetwork, and wherein the computation node is associated with the second subnetwork.

Example 10 includes the method of example 9 or some other example herein, wherein the sn-CP is a first sn-CP associated with a first management node of the first subnetwork, wherein the QoCS flow is a first QoCS flow between the UE and the first management node, wherein the second subnetwork includes a second sn-CP associated with a second management node, and wherein the method further comprises outputting the one or more QoCS parameters to the second sn-CP to configure a second QoCS flow between the computation node and the second management node.

Example 11 includes the method of example 10 or some other example herein, further comprising establishing, for offloading the compute task, a quality of service (QoS) flow between the first management node and the second management node via a cellular network.

Example 12 includes the method of example 11 or some other example herein, further comprising: generating, for transmission to the cellular network, a request for availability information; receiving, from the cellular network, the availability information to indicate that communication resources of the cellular network are available; and generating, for transmission to the cellular network, a reservation message to reserve the communication resources for offloading the compute task.

Example 13 includes the method of example 10 or some other example herein, further comprising establishing a third QoCS flow between the first management node and the second management node to connect the first QoCS flow with the third QoCS flow.

Example 14 includes processing circuitry to: receive, from a user equipment (UE) of a subnetwork, a request to offload a compute task to a computation node; determine one or more quality of computing services (QoCS) characteristics associated with offloading the compute task; and configure, based on the one or more QoCS characteristics, a QoCS flow between the UE and the computation node. A further example may include an apparatus comprising the processing circuitry and interface circuitry coupled to the processing circuitry to enable communication.

Example 15 includes the processing circuitry of example 14 or some other example herein, wherein the one or more QoCS characteristics include an indication of a computation resource type being a guaranteed computation delay (GCD) type or a non-GCD type.

Example 16 includes the processing circuitry of example 14 or some other example herein, wherein the one or more QoCS characteristics include one or more of: a computation priority level; an indication of an interaction type being a single shot interaction or an iterative interaction; a number of UEs to cooperate on the compute task; a reliability level for the compute task; a security level for the compute task; a numerical precision for the compute task; a delay violation probability or rate; or a default averaging window.

Example 17 includes the processing circuitry of example 14 or some other example herein, wherein the QoCS flow between the UE and the computation node is via a management node of the subnetwork, and wherein the computation node is included in the management node or in another UE of the subnetwork.

Example 18 includes one or more computer-readable media having instructions that, when executed, cause processing circuitry to: generate, for transmission to a management node of a subnetwork, a request to offload a compute task; and receive, based on the request, one or more QoCS rules to indicate one or more computation characteristics for the compute task.

Example 19 includes the one or more computer-readable media of example 18 or some other example herein, wherein the one or more computation characteristics include one or more of: a computation resource type being a guaranteed computation delay (GCD) type or a non-GCD type; a computation priority level; an indication of an interaction type being a single shot interaction or an iterative interaction; a number of UEs to cooperate on the compute task; a reliability level for the compute task; a security level for the compute task; a numerical precision for the compute task; a delay violation probability or rate; or a default averaging window.

Example 20 includes the one or more computer-readable media of example 18 or some other example herein, wherein the one or more QoCS rules include an ID of a computation node to which the compute task is to be offloaded and a subnetwork QoCS identifier to indicate the one or more computation characteristics.

Another example may include an apparatus comprising means to perform one or more elements of a method described in or related to any of examples 1-20, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Another example may include an apparatus comprising logic, modules, or circuitry to perform one or more elements of a method described in or related to any of examples 1-20, or any other method or process described herein.

Another example may include a method, technique, or process as described in or related to any of examples 1-20, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-20, or portions thereof.

Another example may include a signal as described in or related to any of examples 1-20, or portions or parts thereof.

Another example may include a datagram, information element, packet, frame, segment, PDU, or message as described in or related to any of examples 1-20, or portions or parts thereof, or otherwise described in the present disclosure.

Another example may include a signal encoded with data as described in or related to any of examples 1-20, or portions or parts thereof, or otherwise described in the present disclosure.

Another example may include a signal encoded with a datagram, IE, packet, frame, segment, PDU, or message as described in or related to any of examples 1-20, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Another example may include a computer program comprising instructions, wherein execution of the program by a processing element is to cause the processing element to carry out the method, techniques, or process as described in or related to any of examples 1-20, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
receiving, from a user equipment (UE) of a subnetwork, a request to offload a compute task;
identifying a computation node to which to offload at least a portion of the compute task, wherein the computation node is associated with the subnetwork or another subnetwork;
determining one or more quality of computing services (QoCS) parameters for a QoCS flow to be used to offload the compute task; and
outputting the one or more QoCS parameters to configure the QoCS flow.

2. The method of claim 1, wherein outputting the one or more QoCS parameters to configure the QoCS flow includes outputting the one or more QoCS parameters to a subnetwork control plane (sn-CP), wherein the sn-CP is to send QoCS control information to the UE and the computation node to configure the QoCS flow based on the one or more QoCS parameters.

3. The method of claim 1, wherein the one or more QoCS parameters include an indication of a computation resource type being a guaranteed computation delay (GCD) type or a non-GCD type.

4. The method of claim 3, wherein the computation resource type is the GCD type, and wherein the one or more QoCS parameters further include one or more of:
a computation power;
a subnetwork compute notification control indicator to indicate whether a notification is requested when the GCD can no longer be guaranteed; or
an aggregate bitrate required for the QoCS flow, wherein the QoCS flow includes multiple UEs.

5. The method of claim 1, wherein the one or more QoCS parameters include one or more of:
a computation priority level;
an indication of an interaction type being a single shot interaction or an iterative interaction;
a number of UEs to cooperate on the compute task;
a reliability level for the compute task;
a security level for the compute task;
a numerical precision for the compute task;
a delay violation probability or rate; or
a default averaging window.

6. The method of claim 1, wherein outputting the one or more QoCS parameters includes outputting a subnetwork QoCS identifier to indicate the one or more QoCS parameters, and wherein the method further comprises outputting a quality of service (QoS) identifier to indicate one or more QoS characteristics for communication associated with offloading the compute task.

7. The method of claim 1, wherein outputting the one or more QoCS parameters includes outputting a joint indicator to indicate the one or more QoCS parameters and one or more quality of service (QoS) characteristics for communication associated with offloading the compute task.

8. The method of claim 1, wherein the computation node is another UE of the subnetwork.

9. The method of claim 1, wherein the subnetwork is a first subnetwork, the another subnetwork is a second subnetwork, and wherein the computation node is associated with the second subnetwork.

10. The method of claim 9, wherein the first subnetwork includes a first subnetwork control plane (sn-CP) associated with a first management node, wherein the QoCS flow is a first QoCS flow between the UE and the first management node, wherein the second subnetwork includes a second sn-CP associated with a second management node, and wherein the method further comprises outputting the one or more QoCS parameters to the second sn-CP to configure a second QoCS flow between the computation node and the second management node.

11. The method of claim 10, further comprising establishing, for offloading the compute task, a quality of service (QoS) flow between the first management node and the second management node via a cellular network.

12. The method of claim 11, further comprising:
generating, for transmission to the cellular network, a request for availability information;
receiving, from the cellular network, the availability information to indicate that communication resources of the cellular network are available; and
generating, for transmission to the cellular network, a reservation message to reserve the communication resources for offloading the compute task.

13. The method of claim 10, further comprising establishing a third QoCS flow between the first management node and the second management node to connect the first QoCS flow with the third QoCS flow.

14. An apparatus comprising:
processing circuitry to:
receive, from a user equipment (UE) of a subnetwork, a request to offload a compute task to a computation node;
determine one or more quality of computing services (QoCS) characteristics associated with offloading the compute task; and
configure, based on the one or more QoCS characteristics, a QoCS flow between the UE and the computation node; and
interface circuitry coupled to the processing circuitry to enable communication.

15. The apparatus of claim 14, wherein the one or more QoCS characteristics include an indication of a computation resource type being a guaranteed computation delay (GCD) type or a non-GCD type.

16. The apparatus of claim 14, wherein the one or more QoCS characteristics include one or more of:
a computation priority level;
an indication of an interaction type being a single shot interaction or an iterative interaction;
a number of UEs to cooperate on the compute task;
a reliability level for the compute task;
a security level for the compute task;
a numerical precision for the compute task;
a delay violation probability or rate; or
a default averaging window.

17. The apparatus of claim 14, wherein the QoCS flow between the UE and the computation node is via a management node of the subnetwork, and wherein the computation node is included in the management node or in another UE of the subnetwork.

18. One or more non-transitory, computer-readable media having instructions that, when executed, cause processing circuitry to:
generate, for transmission to a management node of a subnetwork, a request to offload a compute task; and
receive, based on the request, one or more QoCS rules to indicate one or more computation characteristics for the compute task.

19. The one or more non-transitory, computer-readable media of claim 18, wherein the one or more computation characteristics include one or more of:
a computation resource type being a guaranteed computation delay (GCD) type or a non-GCD type;
a computation priority level;
an indication of an interaction type being a single shot interaction or an iterative interaction;
a number of UEs to cooperate on the compute task;
a reliability level for the compute task;
a security level for the compute task;
a numerical precision for the compute task;
a delay violation probability or rate; or
a default averaging window.

20. The one or more non-transitory, computer-readable media of claim 18, wherein the one or more QoCS rules include an ID of a computation node to which the compute task is to be offloaded and a subnetwork QoCS identifier to indicate the one or more computation characteristics.
